(19) United States
(12) Patent Application Publication
(10) Pub. No.: US 2025/0041142 A1
(43) Pub. Date: Feb. 6, 2025

(54) SURGICAL FLUID RETENTION DEVICE AND METHOD OF USE

(71) Applicant: NJS Creations LLC, South Harrison Twp., NJ (US)

(72) Inventors: Sean McMillan, South Harrison Twp., NJ (US); Neil McMillan, South Harrison Twp., NJ (US); Julie McMillan, South Harrison Twp., NJ (US); Elizabeth Ford, Glassboro, NJ (US)

(73) Assignee: NJS Creations LLC, South Harrison Twp., NJ (US)

(21) Appl. No.: 18/924,741

(22) Filed: Oct. 23, 2024

Related U.S. Application Data
(63) Continuation-in-part of application No. 18/083,691, filed on Dec. 19, 2022, now abandoned.
(60) Provisional application No. 63/292,674, filed on Dec. 22, 2021.

(51) Int. Cl. A61G 13/10; A47G 27/02

(52) U.S. Cl. CPC A61G 13/102; A47G 27/0206

(57) ABSTRACT

A fluid retention device and method of use is defined for retaining surgical fluids used during surgical operation. The device includes a base and an outer wall attached to the base. The outer wall defines a retention area on the base. An inner wall may also be provided to further define the fluid retention area. The inner wall and/or outer wall may include a hollow interior that is selectively expanded to raise the outer wall from the base and to define an upstanding perimeter around the retention area. The retention area is sufficient to retain at least one medical personnel and an operating table, supporting a surgical patient. Access into the center of the device may be provided by a defined separation line radially across one side of the device. Sealing tape may be used to connect and seal the separation.

### CROSS REFERENCE TO RELATED APPLICATION

The present application is a continuation-in-part of co-pending US Regular Utility application Ser. No. 18/083,691, filed Dec. 19, 2022, which claims the benefit of the filing of U.S. Provisional Patent Application Ser. No. 63/292,674, filed Dec. 22, 2021. Each of these prior applications is herein incorporated by reference.

### SUMMARY OF THE INVENTION

A fluid retention device is contemplated for use during surgical procedures. In use, the device retains exasperated and exhausted irrigation fluids for proper disposal.

### BACKGROUND OF THE INVENTION

As an example, during arthroscopic knee surgery fluids, such as a saline solution, are pumped into the patient's knee to expand and irrigate the internal area where surgery is to be performed. The fluids are expelled from the knee through a formed outlet and typically flow into the area adjacent the patient. Other fluids and material may also be exasperated during surgery. A significant portion of the fluids may accumulate on the floor, adjacent the operating table. Presently floor mats, pads and towels are used to absorb these fluids. Suction-pump may be used to help capture or remove the fluid. However, these absorbent materials can create obstacles to movement by the attending medical personnel. The fluids may also create obstacles on the floor surface. Further, clean-up may slow the turn-around time in making the surgery center available for another operation or procedure.

### SUMMARY

In embodiments, a fluid retention device may be defined for retaining surgical fluids used during a surgical operation (medical procedure). The device may include a base and an outer or peripheral wall attached to the base. The outer wall may define an internal retention area on the base. The outer wall preferably includes a hollow interior that is selectively expanded to raise the outer wall from the base and define an upstanding perimeter around the retention area. The retention area is sufficient to surround at least one medical personnel and an operating table, supporting a surgical patient. A suction pump may be provided for removing the surgical fluids retained within the retention area and for delivering the fluids outside of the area.

In embodiments, the wall may be defined by at least one hollow chamber forming the wall interior. Port means may be attached to the outer wall for selectably sealing the hollow chamber. The device may also include in the combination suction pump means for suctioning the surgical fluids within the retention area and for delivering the fluids outside of the retention area. The device may include one or more openings adjacent a portion of the outer wall or within the base area, providing space for pump tubes to pass therethrough. The at least one opening may be formed at a corner position of the outer wall and further may be formed by a separation between the outer wall and the base. The device in combination may also include a mat structure positioned on a top surface of the base and within the retention area. The mat structure may include a resilient and/or frictional coating for the standing surface.

In embodiments, a method of performing a surgical operation including the use of surgical irrigation fluids may be defined by providing at least one medical personnel for performing a surgical operation, an operating table, and a fluid retention device providing a retention area surrounding the medical personnel and the operating table. The fluid retention device may include a base and an outer wall attached to the base. The outer wall defines the retention area. The outer wall includes a hollow interior that is expandable to raise the outer wall above a top surface of the base. The medical personnel and the operating table are positioned within the retention area during the surgical operation and the outer wall retains the discharged fluids.

In embodiments, the method may include the provision of a suction pump for removing surgical fluids retained within the retention area and for directing the fluids outside of the retention area. Further, a mat structure may be provided on a top surface of the base and within the retention area. The mat structure preferably includes a resilient coating that forms a friction surface for the medical personnel.

In embodiments, a fluid retention device for retaining surgical fluids used during a surgical operation may include a flexible, and preferably, planer base, an outer wall attached to the base and defining an outer periphery and an inner wall attached to the base and defining an inner periphery. The base may extend between the inner and outer walls and define a fluid retention area between the walls. The inner wall may define a platform area inwardly of the inner periphery, with the platform area adapted to receive an operating table or similar structure to be used during a surgical operation. The inner and outer walls preferably have a hollow interior that is selectively expanded or inflated to raise the wall from the base to respectively define a resilient and upstanding inner and outer perimeter for the fluid retention area. A gap or separation line may be defined within the inner wall, the base within the retention area, and the outer wall. The separation line formed for selective parting the respective portions of the inner wall, the base and the outer wall for temporary access by an operating table from outside the outer periphery and into the platform area. A scaling means may be provided for selectively joining the respective opposing portions of the inner wall, the base and the outer wall to close the separation line and to seal the fluid retention area.

In embodiments, the fluid retention area of the fluid retention device may be formed to surround at least one medical personnel adjacent an operating table, supporting a surgical patient, during a surgical operation, the operating table being positioned within the platform area defined by the inner wall. The fluid retention device may further include a standing surface for the fluid retention area and covering a portion of the base area. The standing surface may include an adhesive backed friction tape, wherein the adhesive secures the tape to the base, and wherein the upper surface, opposite the adhesive backing, comprises a frictional enhancing surface.

In embodiments, a kit may be defined with the constituent parts of the device, which is then assembled in preparation of the surgical procedure. The method of assembly of the constituent parts and the positioning of the operating table and medical personnel is also contemplated. Further, after use, the walls may be deflated and the patient removed from the operating theatre. The constituent parts of the device are contemplated to be light weight and flexible, and thus easily disposed of after completion of the procedure and removal of the patient. The medical fluids used during the medical procedure may be collected for disposable in a number of ways, as discussed herein.

### BRIEF DESCRIPTION OF THE DRAWINGS

For the purpose of illustration there is shown in the drawings a number of forms which are presently preferred; it being understood that the invention is not limited to the precise arrangements and instrumentalities shown.

FIG. 1 shows an isometric view of an embodiment of a fluid retention device being used in a surgery center.

FIG. 2 is an isometric view of the device embodiment as shown in FIG. 1.

FIG. 3 is a top plan view of the device embodiment as shown in FIGS. 1 and 2.

FIG. 4 is a side elevation of the device embodiment as shown in FIGS. 1-3.

FIG. 5 is a partial cross sectional view of the device embodiment as taken along line 5-5 in FIG. 4.

FIG. 6 is a isometric view of the device embodiment of FIGS. 1-4 including a supplemental floor member, with a partial exploded view of a portion thereof.

FIG. 7 is a isometric view of the device embodiment of FIGS. 1-4 including a supplemental access opening, with a partial exploded view of a portion thereof.

FIG. 8 shows a top plan view of an embodiment of a fluid retention devices.

FIG. 9 shows an isometric view of the device embodiment of FIG. 8 having an operating platform being positioned within the defined area of the device.

FIG. 10 shows an isometric view of the device embodiment of FIGS. 8 and 9 having the operating platform centrally positioned within the device.

FIG. 11 shows a cross section of the device embodiment of FIGS. 8-10 as taken along line 11-11 in FIG. 10, with the operating platform in its central position.

### DETAILED DESCRIPTION

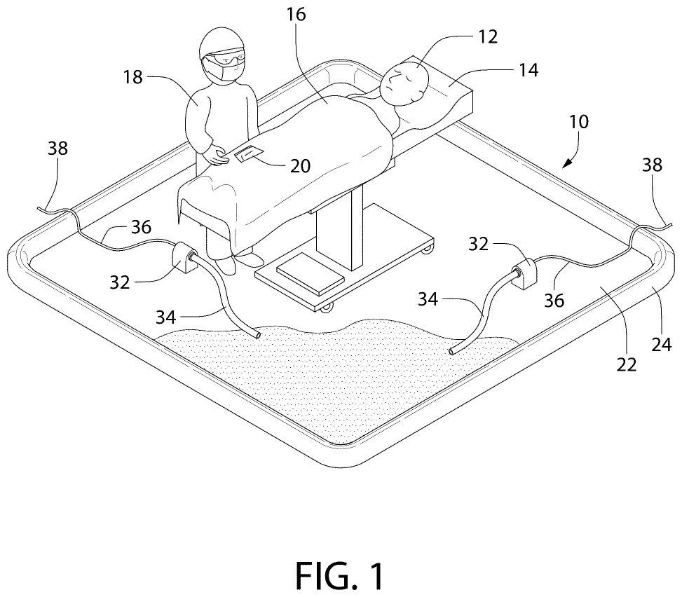

In the drawings, where like numerals identify like elements, there is shown in FIG. 1 an embodiment of a fluid retention device that is generally designated by the numeral 10. The device 10 is positioned within a surgery center, surgical theatre, or other form of operating room having various medical equipment therein. A patient 12 is supported by an operating table 14 and a surgical drape 16 is positioned over the patient 12. A surgeon or other medical personnel 18 is positioned adjacent the patient 12 and operating table 14. An opening 20 is provided within the drape 16 that exposes an area of the patient 12 where the surgery is to be performed. As an example, the surgeon 18 may perform arthroscopic knee surgery. The opening 20 in the drape 18 is positioned adjacent the knee of the patient 12. In the exemplary use of the device, certain fluids, primarily a saline solution, are pumped into the area of the surgery, so as to expand the patient's knee and irrigate the internal area where surgery is to be performed. The fluid is expelled from the knee through a formed outlet (not shown) and typically flows out onto the area adjacent the operating table. A significant portion of the fluid is directed toward the floor on which the device 10 is positioned.

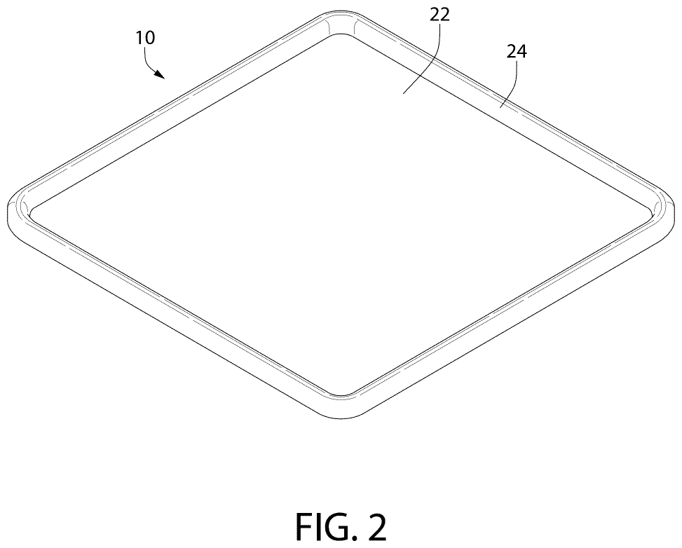

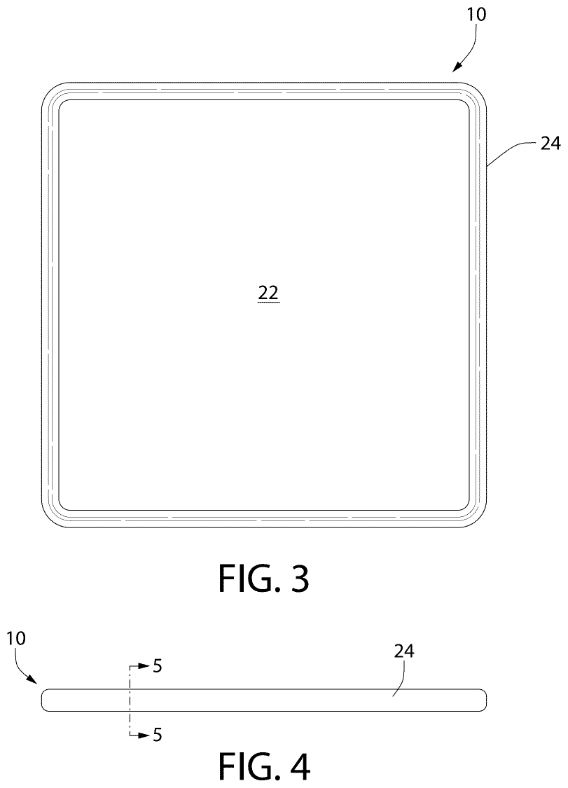

As more particularly shown in FIGS. 2-5, the device 10 includes a base 22 and a surrounding outer or peripheral wall 24, which is connected to the base 22. The outer wall 24 defines the perimeter of the capturing field or retention area of the device 10. Preferably, the perimeter of the base 22 is sealed to the outer wall 24. A valve or similar port means 28 is provided on the outer wall 24, at one or more locations, for the introduction of air or other gas into the wall interior volume 26 to define the perimeter of the retention area. The outer wall 24 is contemplated to be a closed system; thus, the outer wall is air-tight except for the port means 28. The outer wall 24 may define a single chamber or may include a multiple, separate chambers with each having its own port means. The floor is contemplated to be substantially flat and level, although a slope towards a floor drain may be provided. The base material is contemplated to be thin and preferably does not cause or create any variation in the slope.

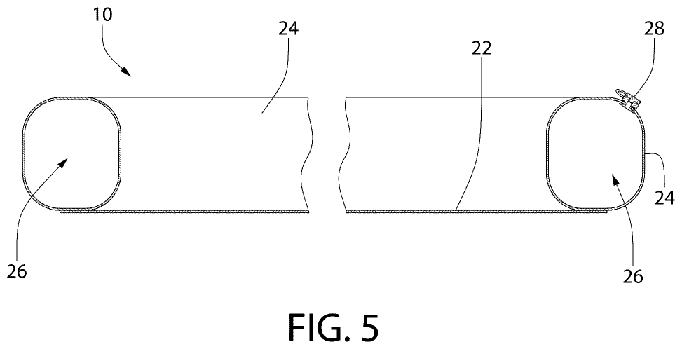

As shown in the cross section of FIG. 5, the interior volume 26 of the outer wall 24 is expanded to create the perimeter barrier for the base 22. Inflation means (not shown) is provided within the surgery center, or separately, to selectively expand the outer wall 24 to form the perimeter barrier around the base 22. The Inflation means may take the form of a mechanical or hand operated pump, or may be a source of compressed air (or other gas). The inflation means is connected to the valve 28 to direct the air into the interior volume 26 of the outer wall 24, so as to expand the outer wall 24. In the closed position, the valve 28 seals the interior volume 26 and the outer wall 24 maintains its expanded condition. The valve 28 may include a flap or other elements to be selectively opened or released so as to exhaust the air from the interior volume 26 of the outer wall 24, so as to permit removal of the device 10 after use.

The base 22 is contemplated to be sufficiently large to permit the operating table 14 and attending medical personnel 18, etc. to stand within the retention area defined by the raised outer wall 24. In one contemplated example, the size of the base may be eighteen (18) feet in length and eight (8) feet in width. The projection of the outer wall 24 is preferably in the range of two to six (2 to 6) inches in height. The height of the wall 24 is contemplated to be adjustable dependent on the amount of air (or gas pressure) within the interior volume of the wall. In other examples, the base may be fourteen (14) feet in length and/or width or may be a ten (10) foot square. A similar preferred wall height is contemplated for the other dimensional embodiments. Other shapes and sizes are possible and contemplated. Variations in the dimensions and footprint of the device are generally limited by the area needed to surround medical personnel and the equipment being used during the surgical procedure.

Once the surgery (medical procedure) is completed, the operating table 14 or a patient transfer vehicle may be wheeled over the outer wall 24, which will preferably collapse at the position of contact. The outer wall 24 is contemplated to be flexible or malleable enough to permit the wheels to roll over the still inflated outer wall 24. The outer wall 24 may alternatively be deflated (in whole or in part) prior to movement of the patient or medical equipment. The fluids retained in the area defined by the outer wall 24 are removed during or after the surgical procedure. Suction may be applied from an external source or otherwise. A exhaust opening may be provided to direct the retained fluids towards a local drain. After exhaust of the retained fluids, the outer wall 24 is collapsed. The device 10 is contemplated to be used in a single surgical procedure before being disposed in a proper manner.

The device 10 is contemplated to be made of a relatively soft, flexible and/or malleable plastic material. The material of both the base 22 and wall 24 is preferably a synthetic medical grade plastic that is impervious. Further, the preferred material will have no absorptive capabilities. The wall material is preferably brightly colored for visibility. Variation in the color or marking patterns may also be utilized. The outer wall is sealed to the based to prevent fluid from passing under the wall. The attachment of the outer wall to the base may be made in any known manner, but is preferably a permanent attachment.

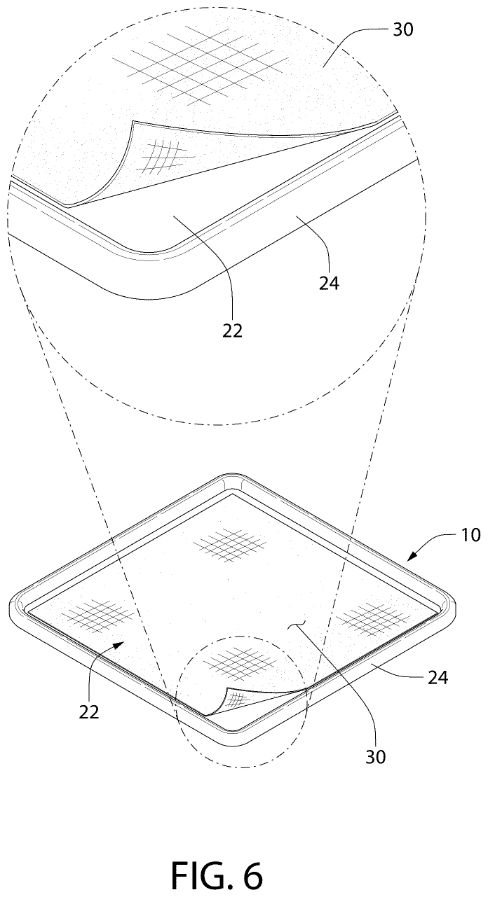

In FIG. 6, the device 10 is provided with a mat or other standing surface structure 30. The mat 30 as shown is preferably flexible and formed separate from the base 22 (and outer wall 24). The mat 30 may be a resilient material having a friction quality that is higher than that of the base material. The mat preferably defines a resilient standing surface and includes a frictional grip on its upper and/or lower surface. The mat 30 may be relatively porous, such as by being formed as an open lattice. The mat 30 is contemplated to be added after inflation of the outer wall 24. Preferably, the mat 30 covers the entire area inside of the wall. However, the mat 30 may be smaller than to the overall base area and be positioned only under the surgeon or at an alternate location. The mat 30 is also contemplated to be disposed of after a single surgical use. As discussed in further detail below, the mat type standing surface may be replaced with an adhesive backed friction tape. The adhesive secures the tape to the base, and the upper surface, opposite the adhesive backing, comprises a frictional enhancing surface. The mat and/or the tape may be strategically positioned on the base where medical personnel are to be positioned during the contemplated medical procedure or may added in multiple areas so as to cover a large portion of the base.

In FIG. 1 there is shown portable suction/pump apparatus 32. One or more apparatus 32 may be placed strategically within the retention area defined by the base 22 and the outer wall 24. An inlet tube 34 is connected to the suction side of the apparatus 32. A separate outlet tube 36 is connected to the outlet side. The free end 38 of the tube 36 is positioned outside the capturing field and preferably connected to a drain or retention reservoir (not shown) to receive the exhausted fluids pumped from the capturing field. Examples of suction-pump devices include a WaterBoom (Registered Trademark) suction strip sold by the Aspen Surgical company of Caledonia, MI. The suction strip includes an elongated body that creates a localized dam to hold back and contain waste fluids. A Colby brand pump device also sold by Aspen Surgical may be attached to the strip. A Neptune brand surgical waste management system as sold by Stryker Corporation of Kalamazoo, MI may also be used, alone or in conjunction with the WaterBoom or similar suction-pump devices. Other suction/pumping devices may also be used.

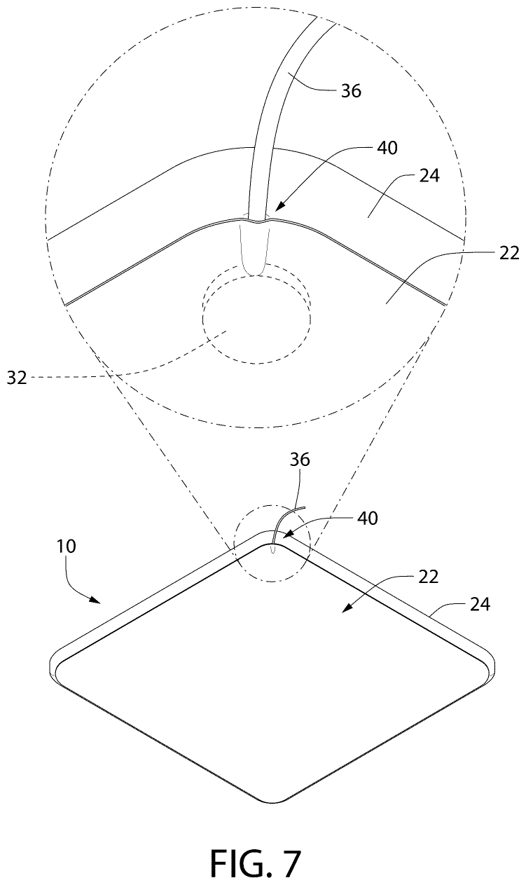

In FIG. 7, there is provided a relatively small opening 40 adjacent on or more corners of the outer wall 24. In embodiments, the openings 40 may be formed by a separation between the perimeter of the base 22 and adjacent portion of the outer wall 24. The openings 40 provide a space for the exhaust tube 36, as an example, to be connected to the suction-pump apparatus 32. Tube 36 may be passed under the outer wall 24 (rather than over the top, as shown in FIG. 1). These openings 40 may be provided at a number of locations along the wall perimeter. Means for selectively sealing the openings 40 when not being used or to otherwise seal around the tube may also be provided. The openings or gaps may also be created by separations in the outer wall. Adjacent chambers or chamber portions may form the overall perimeter of the device, with the openings or chambers positioned therebetween. The air (gas) pressure in the separate chambers or chamber portions may force contact between the adjacent portions, forming a separable scal.

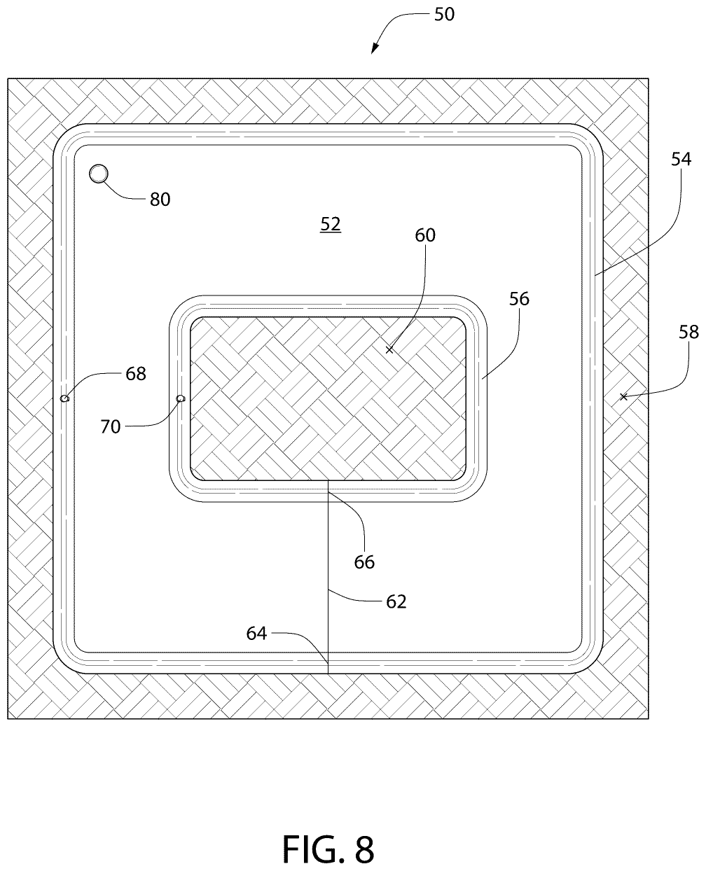

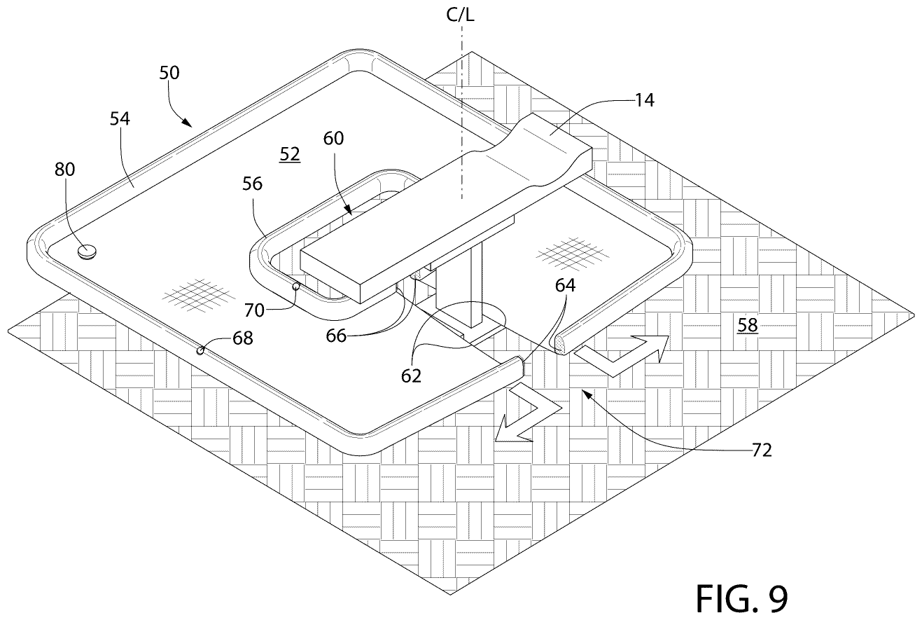

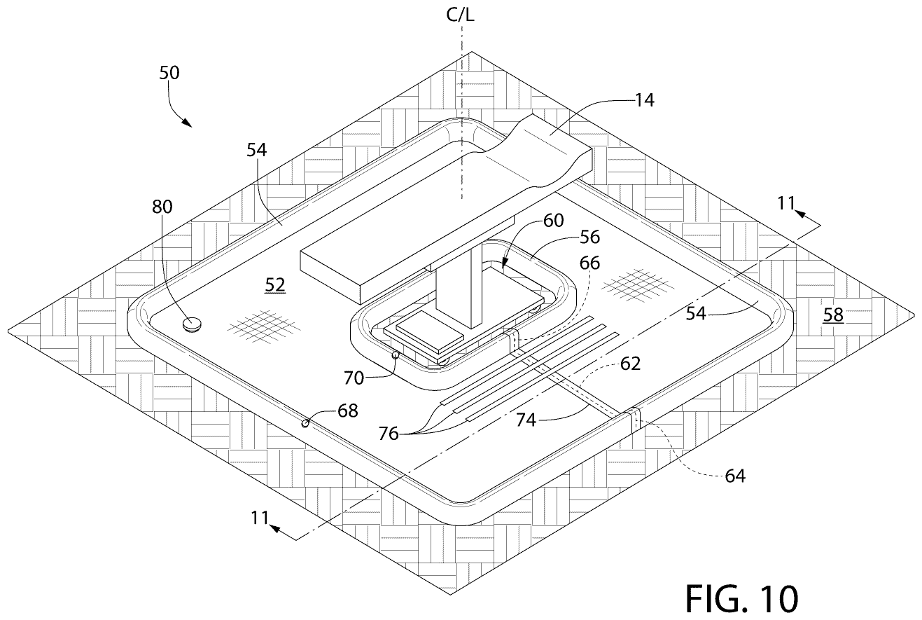

In FIG. 8 there is shown an embodiment of a fluid retention device identified by the number 50. The device 50 comprises a base 52, an outer or peripheral wall 54 and an internal wall 56. A capturing field or retention area is defined by the base internally of the peripheral wall 54 and outwardly of the internal wall 56. Preferably the walls 54, 56 are sealed to the base 52. Alternative attachment means may be provided to secure the walls to the base so as to seal the retention area. The device 50 is shown in FIG. 8 positioned on the floor 58 of the operating room or surgery center. The floor 58 is contemplated to be substantially flat and level, although a slope to a floor drain may be provided. The base material is contemplated to be thin and preferably does not cause or create any variation in the slope. Inwardly of the internal wall 56 is preferably a platform area 58 for receiving an operating table 14, as shown in FIGS. 9 and 10. The platform area 58 is shown as being open and not including a base extension. As shown, the platform area exposes a portion of the operating room floor 58.

A separating line 62 is provided across the base 52 of the device 50. As shown, a peripheral separating line 62 is provided in the peripheral wall 54 and an internal separating line 64 is provided in the internal wall 56. The separating lines 62, 64 and 66 are shown as being radially aligned. However, an offset of one or more of the lines 62, 64, 66 may be provided. Further, the base 52 may be provided with overlapping material to assist in sealing the area. Other geometric shapes and overlaps may be provided to assist in sealing the device 10. The peripheral wall 54 and the internal wall 56 are preferably formed by respective sealed chambers. The walls 54, 56 are inflatable by directing pressurized air (or other gas) therein. Port or valve structures 68, 70 are shown on the respective walls 54, 56 for easy inflation and deflation. The ports 68, 70 may be formed similar to the port 28 on the device embodiment 10, or may be a similar functioning structure. The wall chambers may be continuous or may be formed by separate portions that define the overall wall structure.

In FIG. 9 there is shows the device 50 receiving an operating table 14 through the separation gap 72 formed by the separation lines 62, 64, 66. The operating table is wheeled through the gap 72 after moving the two sides of the base 52 and walls 54, 56 laterally as shown by arrows 74. This separation structure is contemplated to assist in locating the operating table in the platform area 60, surrounded by the device 50. The separation may be made after the walls 54, 56 are inflated or before inflation. If the operating table is fixed, the device 50 may be wrapped around the table 14, while sliding it across the floor 58.

In FIG. 10, the operating table 14 is positioned within the platform area 60 and the base 52 and walls 54, 56 are joined to make a closed retention area. As shown, a sealing tape 74 is provided along the separation line 62, 64, 66. Preferably, a centerline C/L of the table is centrally positioned within the platform area 60 defined by the internal wall 56. However, depending on parameters and needs for various operating procedures, the positioning of the internal wall 56 and the platform opening 60, and thus the centerline C/L of the operating table 14, may be alternately located relative to the peripheral wall 54.

After positioning the table 14 in the platform area 60 defined by the internal wall 56, the respective portions of the inner wall, base and outer wall are joined or otherwise connected at separation lines 62, 64, 66 and preferably sealed to prevent fluid leaking or movement outside of the retention area. The sealing means may be a number of attachment methods, such as hook and loop fastener tabs or strips, snaps, buttons, tape, etc. In FIG. 10, the sealing means is shown as a line of adhesive backed tape 74 is illustrated extending along and overlapping the separation lines 62, 64, 66. Additional connection and/or scaling may be formed by multiple connector types may be used. For example, a series of loops and buttons may be provided at the wall separation lines 64, 66 to engage the adjacent wall portions together, forming a contact seal. As another example, hook and loop type fasteners may be used on the base member 52 separation line 62 to secure the parts together. Preferably, the tape 74, including its carrier portion and adhesive backing, is resistant to the fluids to be used during the surgical operation. Further, the tape 74 or other connection means should be resistant to the foot traffic of the medical personnel.

A standing surface is provided within then fluid retention are. In the example shown in FIG. 10, a plurality of adhesive back, anti-slip or frictional tape strips 76 extend transverse to the separation lines 62 on the base 52 of the device 50. The strips 76 are contemplated to have a rough or friction enhancing top surface and may be of the type used for stair treads or other surfaces, so as to add traction to the surface. The adhesive backing of the strips 76 adheres the strips to the base surface. The strips 76 may be replaced with or supplemented by a mat or pad, as discussed previously herein. The standing surface mat may include an adhesive backing or be otherwise attached to base surface. The strips or other materials preferably provide an increase in traction for the medical personnel attending the medical procedure. The position and location of the strips or other materials may vary depending on the procedure and location of the medical personnel. The anti-slip or slip resistant strips may also be used as the sealing means, such as sealing tape 74, for connecting the base 52 and walls 54, 56 at the respective separation lines 62, 64, 66.

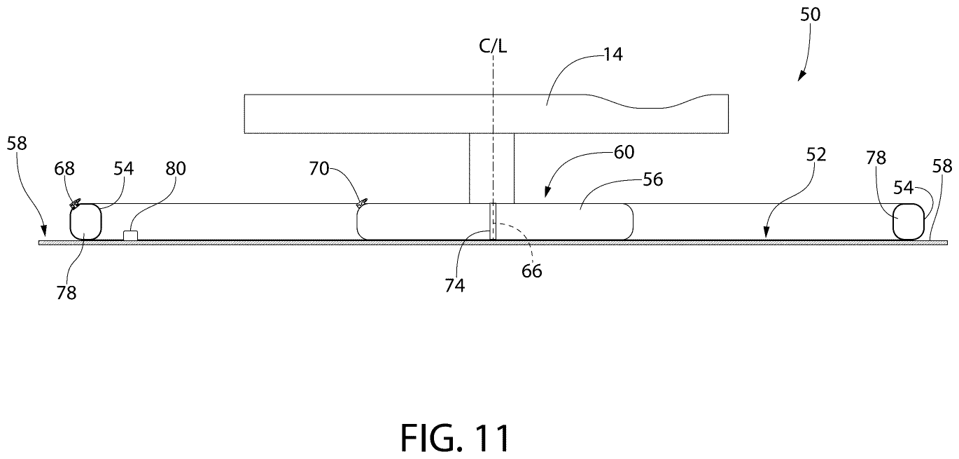

In FIG. 11 there is show a partial cross section of the device 50 as taken along line 11-11 in FIG. 10. The operating table 14 is shown positioned within the platform area 60 and surrounded by the internal wall 56. In the construction shown in FIGS. 8-11, the centerline C/L of the table 14 is centrally positioned between the peripheral wall 54. The peripheral wall 52 is shown in cross section. The interior volume 78 of the two sides of the perimeter wall 54 are expanded to create the perimeter barrier for the device 50. The internal wall 56 is similarly inflated to create the inner barrier, combining to define the retention area. As previously discussed a valve or port 68 is provided on the peripheral wall 54. A similar valve or port 70 is provided on the internal wall 56. The valves 68, 70 may be provide at one or more locations, for the introduction of air (or other gas) into the wall interior, for example interior volume 78. The walls 54, 56 are each contemplated to be a closed system; thus, being air-tight except for the valves 68, 70.

In the figures showing the embodiment of the device 50, a port 80 is provided in the base 52 adjacent a corner of the peripheral wall 54. Other ports may also be provided as desired. The port 80 provides an opening for draining the retention area after the surgical operation. A tube connected to a suction-pump apparatus, as an example, may be directed though the port 80 when opened. Means may be provided for selectively sealing the port 80, when not being used or to otherwise seal the retention area. As alternatives, openings or gaps may be provided in the peripheral wall 54 or in the attachment of the wall 54 to the base 52. As discussed above, pressure in separate chamber portions of the wall may serve to resiliently force contact between the adjacent wall portions forming a separable seal. Similar constructions may be provided in the internal wall 56. A portable suction/pump apparatus may be placed strategically within the retention area similar to that discussed previously herein.

The device 50 may be formed of similar materials as that discussed for the device of FIG. 1. The device 50 is preferably formed in a manner that permits it to be economically assembled and to be disposable after use and draining. The walls 54, 56 and base 52 of the device 50 may be made of a relatively soft, flexible and/or malleable plastic material, such as a synthetic medical grade plastic. The preferred material is impervious and has no absorptive capabilities. The walls are preferably brightly colored for visibility and may have varied color or marking patterns to assist in visibility. The walls 54, 56 are preferably sealed to the base 52 to prevent fluid from passing under the walls. The attachment of the wall to the base may be made in any known manner and may be permanent or by selective attachment. The device 50 may have outer dimensions of ten (10) foot by ten (10) foot square, as an example. Other dimensional forms and sized are possible. The walls 54, 56 are preferably each about six (6) inches in height, although variation is the wall height and thickness are possible.

As depicted in the various figures, a method of performing a surgical operation (medical procedure) including the use of surgical irrigation fluids is defined by providing one or more medical personnel and an operating table within a retention area defined by a fluid retention device. The fluid retention device includes a base and one or more walls attached to the base. The outer or peripheral wall defines the retention area on the base. Further, the walls are formed with a hollow interior that is expandable by the injection of air or another gas. The walls are raised above a top surface of the base. The medical personnel and the operating table are positioned within the retention area during the surgical operation and the outer wall retains the exhausted medical fluids. A suction pump may be provided for moving surgical fluids from within the retention area and directing the fluids outside of the retention area. Alternatively, a port may be provided that serves as a drain for selectively directing the fluids out of the retention area for disposal. A standing surface may be applied inside the fluid retention area, such as friction tape or a mat structure. The mat structure preferably includes a coating of formed surface that adds friction to the standing surface for the medical personnel. Other forms of frictional surfaces may be applied to the retention area of the base, including an adhesive backed tape having a frictional top surface. Further openings may be created by a separating means for directing the operating table into a desired position within the defined barrier of the outer walls.

In the drawings and this specification, there is set forth one or more embodiments and methods of using same. Although specific terms are employed, these terms are used in a generic and descriptive sense and not necessarily for purposes of limitation. The scope of the invention is set forth in the claims.

What is claimed is:

1. A fluid retention device for retaining surgical fluids used during a surgical operation, the device comprising:
a flexible, planer base,
an outer wall attached to the base and defining an outer periphery;
an inner wall attached to the base and defining an inner periphery,
the base extending between the inner and outer walls and defining a fluid retention area,
the inner wall defining a platform area inwardly of the inner periphery, the platform area adapted to receive an operating table during a surgical operation, and
the inner and outer walls having a hollow interior that are each selectively expanded to raise the wall from the base to respectively define a resilient and upstanding inner and outer perimeter for the fluid retention area;
a separation line defined within the inner wall, the base within the retention area, and the outer wall, the separation line formed for selective parting of respective portions of the inner wall, the base and the outer wall for temporary access of an operating table from outside the outer periphery and into the platform area; and
sealing means for selectively joining the respective opposing portions of the inner wall, the base and the outer wall to close the separation line and to seal the fluid retention area.

2. The fluid retention device as claimed in claim 1 wherein the retention area is formed to surround at least one medical personnel adjacent an operating table, supporting a surgical patient, during a surgical operation, the operating table being positioned within the platform area defined by the inner wall.

3. The fluid retention device as claimed in claim 1 further comprising a standing surface provided in the fluid retention area and covering a portion of the base area.

4. The fluid retention device as claimed in claim 3 wherein the standing surface comprises an adhesive backed friction tape, wherein the adhesive secures the tape to the base, and wherein the upper surface, opposite the adhesive backing, comprises a frictional enhancing surface.

5. The fluid retention device as claimed in claim 4 wherein friction tape is applied to the base so as to transverse the separation line.

6. The fluid retention device as claimed in claim 1 wherein the base, inner wall and outer wall are made from a medical grade plastic material.

7. The fluid retention device as claimed in claim 1 wherein the standing surface comprises a mat structure positioned on a top surface of the base within the retention area.

8. The fluid retention device as claimed in claim 1 wherein the outer wall is defined by a single hollow chamber forming the interior, the hollow chamber extending away from the each opposing side of the separation line and extending along the outer periphery defined by the outer wall.

9. The fluid retention device as claimed in claim 1 wherein the inner wall is defined by a single hollow chamber forming the interior, the hollow chamber extending away from each opposing side of the separation line and forming a barrier between the fluid retention area and the inner platform area.

10. The fluid retention device as claimed in claim 8, further comprising port means attached to one or both of the inner wall and the outer wall for selectably sealing the hollow interior of the outer wall.

11. A method of performing a surgical operation including the use of surgical irrigation fluids, the method comprising:
providing at least one medical personnel for performing a surgical operation,
providing an operating table,
providing a fluid retention device comprising
a flexible, planer base,
an outer wall attached to the base and defining an outer periphery, and
an inner wall attached to the base and defining an inner periphery,
wherein the inner and outer walls having a hollow interior that are each selectively expanded to raise the wall from the base to respectively define a resilient and upstanding inner and outer perimeter for the fluid retention area,
wherein the inner wall defines a platform area inwardly of the inner periphery,
wherein the base extends between the inner and outer walls and define a fluid retention area, and;
a separation line defined within the inner wall, the base within the retention area, and the outer wall, the separation line formed for selective parting of respective portions of the inner wall, the base and the outer wall, and
sealing means for selectively joining the respective opposing portions of the inner wall, the base and the outer wall to close the separation line and to seal the fluid retention area;
expanding both the inner and outer walls to be raised above a top surface of the base and defining a barrier for the retention area,
separating the outer wall, base and inner wall at the separation line,
moving the operating table in advance of the surgical operation through the separated outer wall, base and inner wall and positioning the operating table into the platform area;
closing the separation line by bringing the respective opposing sides of the inner wall, base and outer wall into an adjacent alignment; and
sealing the separation line using the sealing means to as to close the fluid retention area.

12. The method as claimed in claim 11 further comprising positioning at least one medical personnel within the retention area, adjacent the operating table positioned within the platform area.

13. The method as claimed in claim 11 wherein the fluid retention device comprises a standing surface, and further comprising positioning the standing surface on the base within the fluid retention area.

14. The method as claimed in claim 13 wherein the standing surface comprises an adhesive backed tape having an top portion forming a friction enhancing surface, and further comprising securing the tape to the base with the adhesive.

15. The method as claimed in claim 4 wherein friction tape is applied to the base so as to transverse the separation line.

16. The method as claimed in claim 11 wherein at least one of the inner and outer walls is provided with port means for selectably sealing the hollow interior, and further comprising inflating the inner and outer walls and closing the port means.

17. A fluid retention device for retaining surgical fluids used during a surgical operation, the device comprising:
a flexible, planer base,
an outer wall attached to the base and defining an outer periphery;
the base extending inwardly from the outer walls and defining a fluid retention area, the retention area formed to surround at least one medical personnel adjacent an operating table, supporting a surgical patient, during the surgical operation, with the operating table being positioned inwardly of the outer wall,
the outer wall having a hollow interior that is selectively expanded to raise the wall from the base to respectively define a resilient and outer perimeter for the fluid retention area; and
a standing surface provided in the fluid retention area and covering a portion of the base area; the standing surface comprising an adhesive backed friction tape, wherein the adhesive secures the tape to the base, and wherein the upper surface, opposite the adhesive backing, comprises a frictional enhancing surface.

18. The fluid retention device as in claim 17 further comprising an inner wall attached to the base and defining an inner periphery for the fluid retention area of the base, the inner wall defining a platform area inwardly of the inner periphery, the platform area adapted to receive an operating table during a surgical operation.

19. The fluid retention device as in claim 18, further comprising
a separation line defined within the inner wall, the base within the retention area, and the outer wall, the separation line formed for selective parting of respective portions of the inner wall, the base and the outer wall for temporary access of an operating table from outside the outer periphery and into the platform area; and
sealing means for selectively joining the respective opposing portions of the inner wall, the base and the outer wall to close the separation line and to seal the fluid retention area.

20. The fluid retention device as claimed in claim 19 wherein friction tape is applied to the base so as to transverse the separation line.
